(19) United States
(12) Patent Application Publication
(10) Pub. No.: US 2002/0014753 A1
(43) Pub. Date: Feb. 7, 2002

(54) Wheel system for traveling body

(76) Inventor: Chun Lung Cheng, La Verne, CA (US)

Correspondence Address: RAYMOND Y. CHAN, 1050 Oakdale Lane, Arcadia, CA, 91006, US

(21) Appl. No.: 09/964,186

(22) Filed: Sep. 25, 2001

(51) Int. Cl. B62B 1/10; B62B 11/00

(52) U.S. Cl. 280/47.26; 190/18 A; 280/47.34; 224/576; 224/153

(57) ABSTRACT

A wheel system, adapted for incorporating with a traveling body, includes at least a pair of wheel assembly for attaching to two outer sides of the traveling body respectively. Each wheel assembly includes a reinforcing panel adapted to be provided at an edge portion of the respective outer side of the traveling body, a wheel shelter extended from the reinforcing panel that defines a wheel cavity between the wheel shelter and the reinforcing panel, and a wheel rotatably supported in the wheel cavity for supporting the traveling body on ground. Therefore, a storage space defined between the two outer sides of the traveling body is maximized and the rigid structure of the traveling body is enhanced.

### BACKGROUND OF THE PRESENT INVENTION

1. Field of Invention

The present invention relates to a traveling container, and more particularly to a wheel system for traveling body, which can provide a simple but rigid support for the traveling body without altering its original structure so as to increase the interior receiving space, prolong the service life span and minimize the manufacturing cost of the traveling body.

2. Description of Related Arts

Referring to FIG. 1, a conventional traveling container comprises a container body and a pair of wheels rotatably mounted on a bottom edge of the container body such that a user is able to conveniently pull the traveling container on ground instead of merely carrying the traveling container from place to place.

In order to a rotatably mount the wheels on the container body, the container body must be provided with two wheel slots spacedly indented on a bottom edge of the container body and comprises two corresponding reinforcing pads, each having two parallel walls mounted on the wheel slots respectively, wherein each of the two wheels is rotatably mounted between the two parallel walls via a wheel axle. However, such wheel attachment has several drawbacks.

The original structural design of the container body must be altered in order to fit the wheels mounted thereto. Typically, the container body is constructed by a plurality of panels which are made of stiff structure, usually metal, to provide a rigid structure of the container body for protecting items inside the container body. The problem with this type of conventional traveling container is that it is bulky, usually very heavy, and difficult to carry. Another type of the traveling container is that the container body comprises a frame constructed to support a fabric shelter thereon. It is no doubt that such type of the traveling container is lightweight and portable. However, no matter which aforementioned type of the traveling container is, its original rigid structure must be altered to mount the wheels thereto. In other words, an auxiliary rigid frame must be incorporated with the container body to compensate the weakest structure thereof. Such complex structure of the container body will highly increase the manufacturing cost and the installation of the traveling container. Also, the container body will increase the overall weight of the traveling container so as to loss most of the ordinary features such as lightweight and portable of the traveling container.

In addition, since portions of the wheels are inserted into the interior of the container body, an interior chamber of the container body will be reduced, especially the spaces around the wheel slots. It is unreasonable to reduce the interior chamber of the container body, which has loss a meaning of storage.

Moreover, since the wheels are mounted within the length of the bottom edge of the container body, the traveling container may easily be flipped over sidewardly, especially while moving on a slanted surface or a rough surface. When the user is pulling the container body having a taller height, such as a golf bag, on the slanted surface, the center of mass of the container body tends to move sidewardly. When the center of mass of the container body falls out of a wheel length which is defined between the two wheels, the container body will be flipped over sidewardly that may damage the items carried inside the container body.

### SUMMARY OF THE PRESENT INVENTION

A main object of the present invention is to provide a wheel system for traveling body, which not only occupies no interior receiving space, but also can reinforce the structure of the traveling body and enhance the traveling body's weight supporting ability.

Another object of the present invention is to provide a wheel system for traveling body, which provides a simple but rigid support for the traveling body without altering the original structure of the traveling body so as to prolong the service life span and minimize the manufacturing cost of the traveling body.

Another object of the present invention is to provide a wheel system for traveling body, which maximizes the interior space of the traveling body for storage.

Another object of the present invention is to provide a wheel system for traveling body, which maximizes a wheel length between two wheels so as to enhance the stabilization of the traveling body while moving.

Another object of the present invention is to provide a wheel system for traveling body, wherein the wheel can be constructed selectively attached to the traveling body for carriage and detached from the traveling body for storage.

Another object of the present invention is to provide a wheel system for traveling body, wherein no expensive or complicate mechanical structure is required to employ in the present invention in order to achieve the above mentioned objects. Therefore, the present invention successfully provides an economic and efficient solution for selectively attaching to the traveling body and providing reinforced support configuration to the traveling body.

Accordingly, in order to accomplish the above objects, the present invention provides a wheel system for traveling body having two opposing outer sides. The wheel system comprises at least a pair of wheel assembly for attaching to the two outer sides of the traveling body respectively. Each wheel assembly a reinforcing panel adapted to be provided at an edge portion of the respective outer side of the traveling body, a wheel shelter extended from the reinforcing panel that defines a wheel cavity between the wheel shelter and the reinforcing panel, and a wheel rotatably supported in the wheel cavity for supporting the traveling body on ground. Therefore, a storage space defined between the two outer sides of the traveling body is maximized and the rigid structure of the traveling body is enhanced too.

### BRIEF DESCRIPTION OF THE DRAWINGS

FIG. 1 is an exploded perspective view of a conventional wheel attachment for traveling container.

FIG. 2 is a perspective view of a wheel system incorporated with a traveling body according to first preferred embodiment of the present invention.

FIG. 3 is an exploded perspective view of the wheel system for traveling body according to the above first preferred embodiment of the present invention.

FIG. 4A is a sectional view of the wheel system for traveling body according to the above first preferred embodiment of the present invention.

FIG. 4B illustrates an alternative mode of an attaching means of the wheel system according to the above first preferred embodiment of the present invention.

FIG. 5 illustrates a first alternative mode of the wheel system for traveling body according to the above first preferred embodiment of the present invention.

FIG. 6 illustrates a second alternative mode of the wheel system for traveling body according to the above first preferred embodiment of the present invention.

FIG. 7A is an isometric drawing of the deviated force center on the conventional wheel attachment.

FIG. 7B is isometric drawing of the deviated force center on the wheel system for traveling body according to the above first preferred embodiment of the present invention.

FIG. 8 is a perspective view of a wheel system for traveling body according to a second preferred embodiment of the present invention.

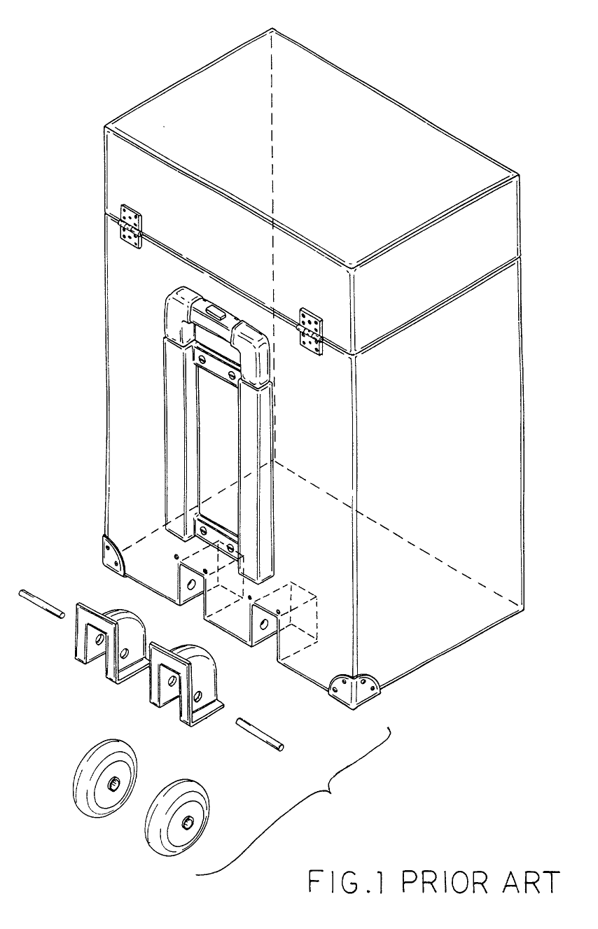

### DETAILED DESCRIPTION OF THE PREFERRED EMBODIMENT

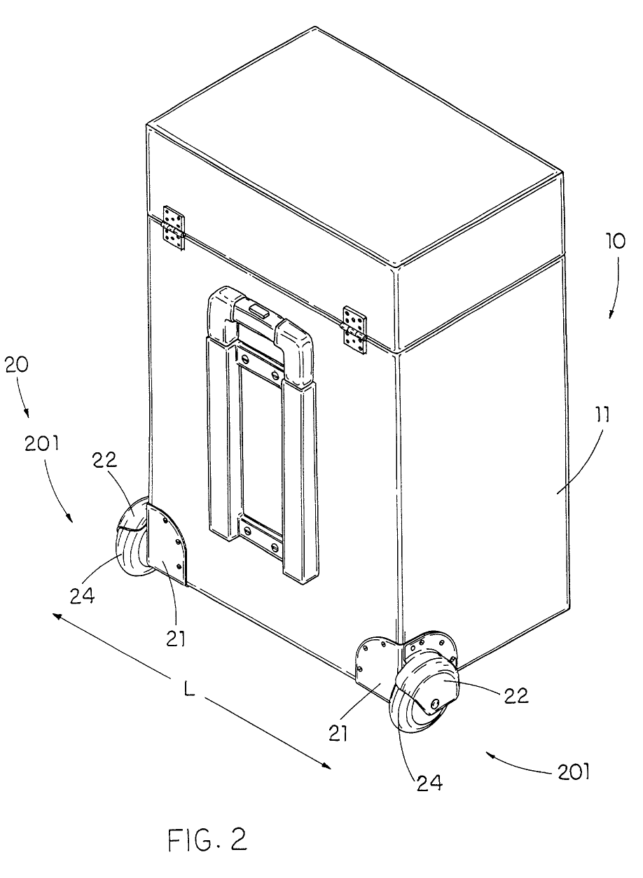

Referring to FIG. 2 of the drawings, a traveling body 10 incorporated with a wheel arrangement 20 according to a first preferred embodiment of the present invention is illustrated, wherein the traveling body 10, such as a traveling container, has two parallel outer sides 11 spaced apart with each other.

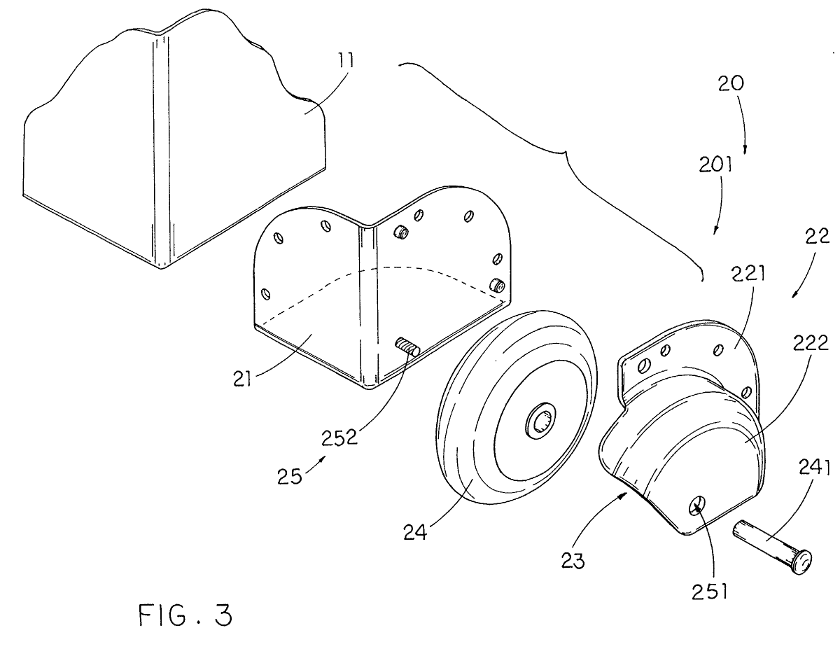

As shown in FIG. 3, the wheel system 20 comprises at least a pair of wheel assembly 201 for attaching to the two outer sides 11 of the traveling body 10. Each wheel assembly 201 comprises a reinforcing panel 21 securely mounted on the respective outer side 11 of the traveling body 10, a wheel shelter 22 extended from the reinforcing panel 21 defining a wheel cavity 23 between the wheel shelter 22 and the reinforcing panel 21, and a wheel 24 rotatably supported in the wheel cavity 23.

According to the first preferred embodiment, each of the reinforcing panels 21, having a predetermined shape, is capable of fittedly mounting on the outer sides 11 of the traveling body 10. The reinforcing panel 21 can be a flat metal plate affixed on the respective outer side 11 of the traveling body 10. As shown in FIG. 3, the reinforcing panel 21 is embodied to comprise three pieces perpendicularly to each other for fittedly mounting on a corner portion of the outer side 11 of the traveling body 10. It is worth to mention that the reinforcing panel 21 can also protect the corner of the traveling body 10 so as to enhance the rigid structure of the traveling body 10. Accordingly, the reinforcing panel 21 is preferred to be detachably attached to the respective outer side 11 of the traveling body 10. In other words, each of the wheel assembly 201 is capable of detachably attaching to the traveling body 10. Alternatively, the reinforcing panel 21 can also be permanently affixed to the traveling body 10 to become the corner protection for the traveling body 10.

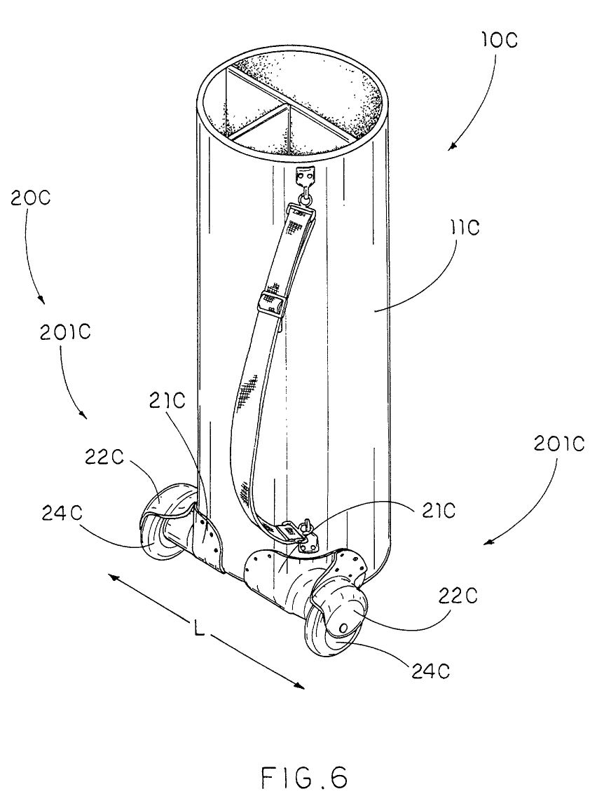

Each of the wheel shelters 22 comprises a connecting rim 221 and a wheel cover 222. The connecting rim 221, having a L-shaped cross section, is detachably attached to the respective reinforcing panel 21 by means of at least a bolt. The wheel cover 222, having an arc-shaped cross section, integrally extended from the connecting rim 221, wherein the wheel cavity 23 is defined between the wheel cover 222 and the reinforcing panel 21. It is worth to mention that the wheel cover 222 has a size adapted for sheltering an arc portion of the wheel 24, which is less than 180 degrees thereof, as shown in FIGS. 3 and 6.

Each of the wheels 24 is rotatably supported in the respective wheel cavity 23 by rotatably mounting on a wheel axle 241. The wheel 24 is preferably made of lightweight but durable material such as plastic or rubber so as to provide a portable and rigid feature for the traveling body 10.

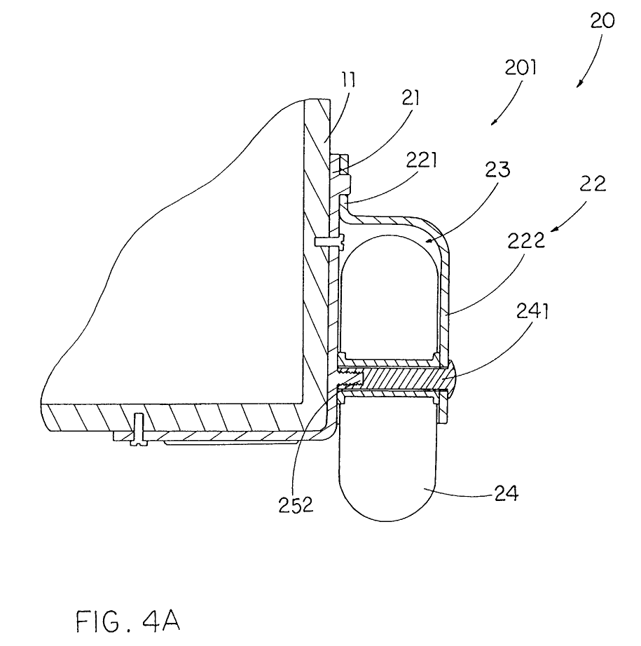

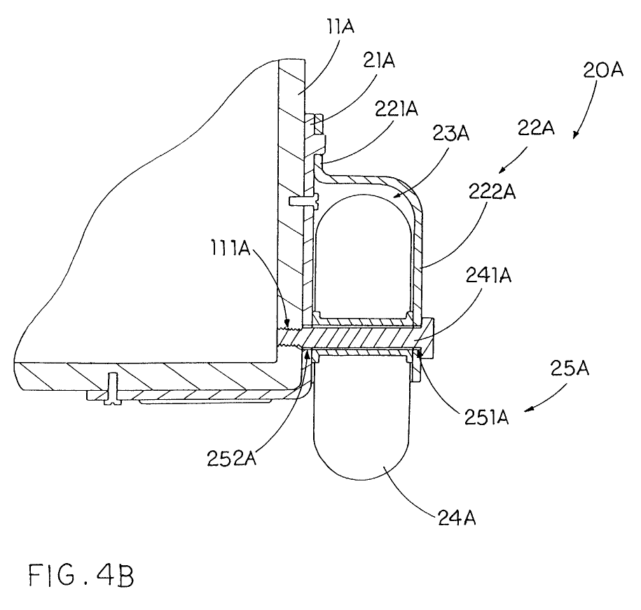

Each of the wheel assemblies 201 further comprises an attachment means 25 for rotatably supporting the wheel 24 between the reinforcing panel 21 and the wheel shelter 22, wherein the attachment means 25 has a through hole 251 provided on the wheel cover 222 and a tubular holder 252, having a predetermined size, protruded from the reinforcing panel 21, wherein the wheel axle 241 passes through the through hole 251 until an inner end of the wheel axle 241 inserted into the holder 252. So, the wheel axle 241 is rigidly supported between the reinforcing panel 21 and the wheel cover 222 so as to rotatably support the wheel 24 therebetween by passing the wheel axle 241 through a center hole of the wheel 24, as shown in FIG. 4A.

Alternatively, the attachment means 25A has a pair of first and second through holes 251A, 252A provided on the reinforcing panel 21A and the wheel shelter 22A respectively, wherein the wheel axle 241 passes through the second through hole 252A and inserts into the first through hole 251A, so as to rotatably support the wheel 24A between the reinforcing panel 21A and the wheel shelter 22A, as shown in FIG. 4B. Accordingly, the inner end of the wheel axle 241A has an outer thread portion adapted to rotatably screw into a mounting hole 111A which has an inner thread portion formed on the respective outer side 11A of the traveling body 10A in order to rotatably support the wheel 24A by the wheel axle 241A.

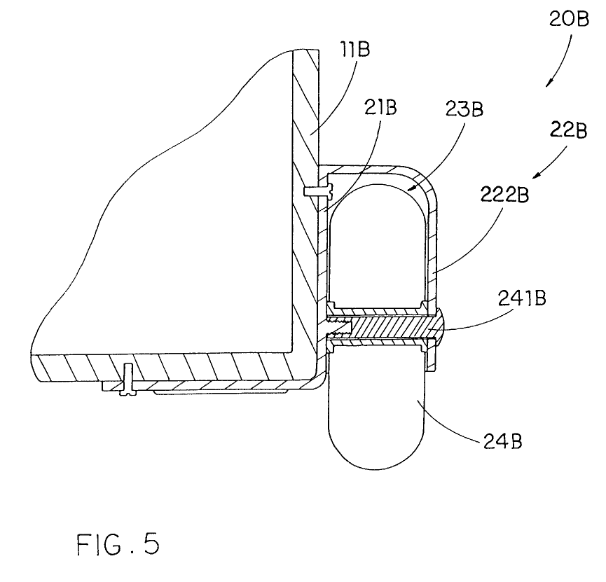

FIG. 5 illustrates a first alternative mode of the wheel system 20B wherein the wheel shelter 22B comprises a wheel cover 222B, having a L-shaped cross section, integrally extended from the reinforcing panel 21B to form a U-shaped cross sectional structure and define the wheel cavity 23A between the reinforcing panel 21B and the wheel cover 222B. Therefore, the wheel system 20B is capable of detaching from the outer sides 11B of the traveling body 10B without disassembling the wheels 24B from the wheel cavities 23B respectively.

FIG. 6 illustrates a second alternative mode of the wheel system 20C, wherein the reinforcing panel 21C which has a predetermined width is arranged to be spacedly mounted on the respective outer side 11C of the traveling body 10C, so as to lengthen a wheel length L of the wheel system 20C.

The wheel length L is a distance defined between the two wheels 24, wherein the longer distance of the wheel length L is, the more stable of the traveling body 10 can achieved. In the above preferred embodiment, the two wheels 24 are spacedly mounted on the two outer sides 11 of the traveling body 10 wherein the wheel length L of the wheel system 20 is longer than a distance between the two outer sides 11 of the traveling body 10. Therefore, the traveling body 10 is more stable while it is operatively moving.

As shown in FIG. 6, the reinforcing panels 21C are extended to space apart from the two outer sides 11C of the traveling body 10C, such that the wheel length L of the wheel system 20C, which is a distance between the two wheel assemblies 201C, can be substantially increased by the widths of the reinforcing panels 21C. Especially for the traveling body 20C having a taller height, such as a golf bag, the traveling body 20C may easily flip over sidewardly when the traveling body 20C is pulling on a slanted surface or a rough surface.

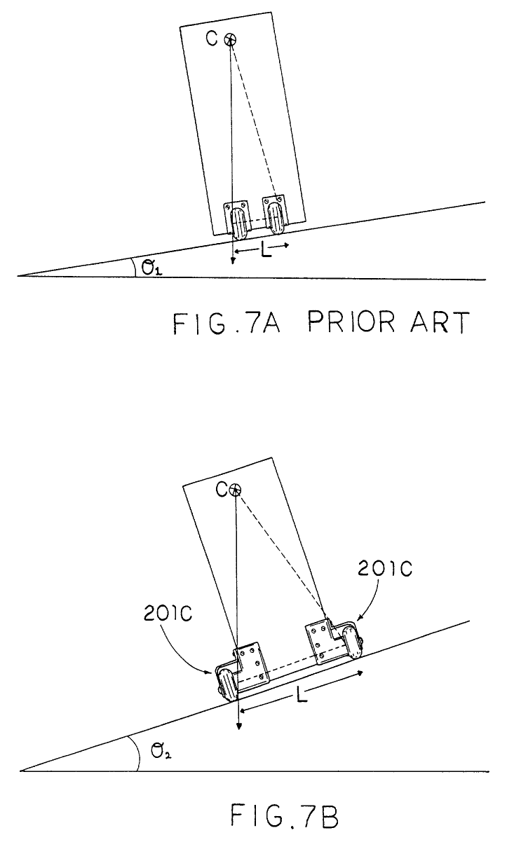

FIGS. 7A and 7B illustrate how the wheel length L affect the stabilization of the traveling body 10 on the slanted surface. As shown in FIG. 7A, a conventional traveling body is illustrated wherein the wheel length L has a distance shorter than the width of the traveling body. For example, the distance of the center of mass C of the traveling body 10 is 3 feet from the ground and the wheel length L of the traveling body 10 is 1 foot long. The maximum inclined angle θ₁ of the slanted surface to maintain the traveling body 10 in a stabilized manner is 9.46 degrees. In other words, when the traveling body 10 is being moved on the slanted surface having an inclined angle θ₁ greater than 9.46 degrees, the traveling body 10 will flip over.

As shown in FIG. 7B, when the wheels 24 are spacedly located at the two outer sides 11 of the traveling body 10 so as to substantially increase the wheel length L, for example 2 feet. Therefore, the maximum inclined angle θ₂ of the slanted surface to maintain the traveling body 10 in a stabilized manner is 18.43 degrees. In comparison with the conventional traveling body 10, the traveling body 10 incorporated with the wheel system 20 of the present invention is more stable than the conventional one. In other words, the user is able to handle the traveling body 10 easily.

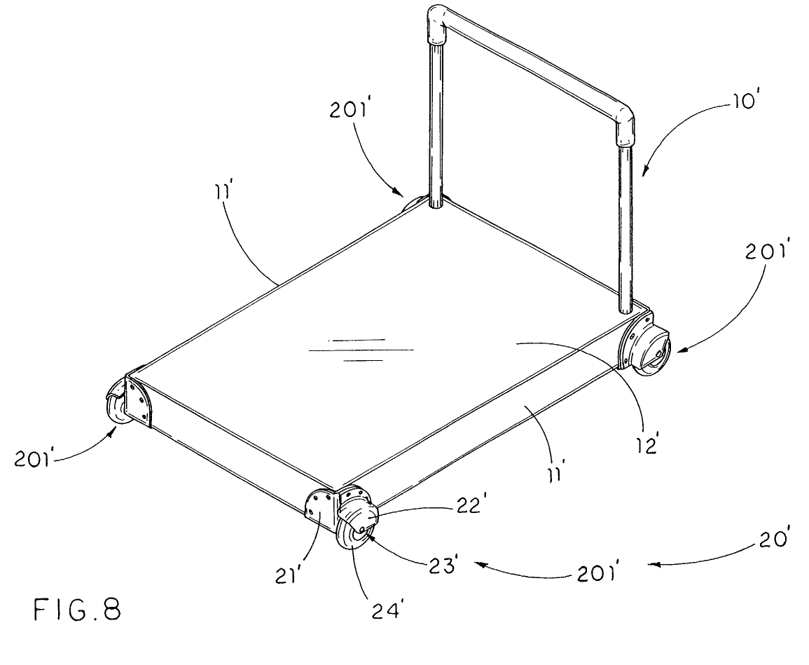

Referring to FIG. 8 of the drawings, a second embodiment illustrates another alternative mode of the above first embodiment of the present invention, wherein the wheel system 20′ is adapted for incorporating with the traveling body 10′ which is embodied as a dolly.

As shown in FIG. 8, the traveling body 10′ comprises a platform 12′ has the two outer sides 11′ thereof. There are four wheel assemblies 201′ spacedly attached to the outer sides 11′ of the platform 12′ respectively. Therefore, four reinforcing panels 21′ for securely attaching to two outer sides 11′ of the traveling body 11′ respectively, four wheel shelters 22′ extended from the four reinforcing panels 21′ so as to define four wheel cavities 23′ between the wheel shelters 22′ and the reinforcing panels 21′ respectively, and four wheels 24′ rotatably disposed in the four wheel cavities 23′ respectively, so as to substantially support the traveling body 10′. Since the wheels 24′ are positioned on the outer sides 11′ of the traveling body 10′, the platform 12′ can provide a maximum space for supporting items thereon.

The advantages of the wheel system of the present invention include the following:

1. The wheels are rotatably attached to the outer sides of the traveling body, such that the traveling body does not require to alter its original structural design that may weaken the structure of the traveling body. Thus, the wheel system can not only substantially support the traveling body but also enhance the rigid structure of the traveling body and reduce the manufacturing cost of the traveling body incorporating with the wheel system.

2. The wheel system can substantially increase the wheel distance for stabilizing the traveling body. Therefore, even through the traveling body has a relative higher height, the traveling body can still be operatively moved in a stable manner by lengthening the wheel distance of the wheel system.

3. Since the traveling body can maintain its original structure, the traveling body can obtain the maximum interior storage space. In other words, the traveling body incorporated with the wheel system of the present invention can provide more space for storage.

What is claimed is:

1. A wheel system for a traveling body having two opposing outer sides, comprising a pair of wheel assemblies mounted on said two outer sides respectively, wherein each of said wheel assemblies comprises:
a reinforcing panel adapted to be provided at an edge portion of said respective outer side of said traveling body;
a wheel shelter extended from said reinforcing panel that defines a wheel cavity between said wheel shelter and said reinforcing panel; and
a wheel rotatably supported in said wheel cavity for supporting said traveling body on ground.

2. The wheel system, as recited in claim 1, wherein said wheel shelter comprises a connecting rim, having a L-shaped cross section, is detachably attached to said reinforcing panel and a wheel cover, having an arc shaped cross section, integrally extended from said connecting rim wherein said wheel cavity is defined between said wheel cover and said reinforcing panel.

3. The wheel system, as recited in claim 1, wherein said wheel shelter comprises a wheel cover, having a L-shaped cross section, integrally extended from said reinforcing panel to form a U-shaped cross sectional structure, so as to define said wheel cavity between said reinforcing panel and said wheel cover.

4. The wheel system, as recited in claim 1, wherein each of said wheel assemblies further comprises an attachment means for rotatably supporting said wheel in said wheel cavity, wherein said attachment means contains a wheel axle mounted between said reinforcing panel and said wheel shelter, a through hole provided on said wheel cover, and a tubular holder, having a predetermined size, protruded from said reinforcing panel wherein said wheel axle passes through said through hole and a center hole of said wheel until an inner end of said wheel axle inserted into said holder.

5. The wheel system, as recited in claim 2, wherein each of said wheel assemblies further comprises an attachment means for rotatably supporting said wheel in said wheel cavity, wherein said attachment means contains a wheel axle mounted between said reinforcing panel and said wheel shelter, a through hole provided on said wheel cover, and a tubular holder, having a predetermined size, protruded from said reinforcing panel wherein said wheel axle passes through said through hole and a center hole of said wheel until an inner end of said wheel axle inserted into said holder.

6. The wheel system, as recited in claim 3, wherein each of said wheel assemblies further comprises an attachment means for rotatably supporting said wheel in said wheel cavity, wherein said attachment means contains a wheel axle mounted between said reinforcing panel and said wheel shelter, a through hole provided on said wheel cover, and a tubular holder, having a predetermined size, protruded from said reinforcing panel wherein said wheel axle passes through said through hole and a center hole of said wheel until an inner end of said wheel axle inserted into said holder.

7. The wheel system, as recited in claim 1, wherein each of said wheel assemblies further comprises an attachment means for rotatably supporting said wheel in said wheel cavity, wherein said attachment means contains a wheel axle mounted between said reinforcing panel and said wheel shelter, and a pair of first and second through holes provided on said reinforcing panel and said wheel shelter respectively, wherein said wheel axle passes through said second through hole and inserts into said first through hole through a center hole of said wheel.

8. The wheel system, as recited in claim 2, wherein each of said wheel assemblies further comprises an attachment means for rotatably supporting said wheel in said wheel cavity, wherein said attachment means contains a wheel axle mounted between said reinforcing panel and said wheel shelter, and a pair of first and second through holes provided on said reinforcing panel and said wheel shelter respectively, wherein said wheel axle passes through said second through hole and inserts into said first through hole through a center hole of said wheel.

9. The wheel system, as recited in claim 3, wherein each of said wheel assemblies further comprises an attachment means for rotatably supporting said wheel in said wheel cavity, wherein said attachment means contains a wheel axle mounted between said reinforcing panel and said wheel shelter, and a pair of first and second through holes provided on said reinforcing panel and said wheel shelter respectively, wherein said wheel axle passes through said second through hole and inserts into said first through hole through a center hole of said wheel.

10. The wheel system, as recited in claim 7, wherein an inner end of said wheel axle has an outer portion adapted for rotatably screwing into a mounting hole which has an inner thread portion formed on said respective outer side of said traveling body in order to rotatably support said wheel by said wheel axle.

11. The wheel system, as recited in claim 8, wherein an inner end of said wheel axle has an outer portion adapted for rotatably screwing into a mounting hole which has an inner thread portion formed on said respective outer side of said traveling body in order to rotatably support said wheel by said wheel axle.

12. The wheel system, as recited in claim 9, wherein an inner end of said wheel axle has an outer portion adapted for rotatably screwing into a mounting hole which has an inner thread portion formed on said respective outer side of said traveling body in order to rotatably support said wheel by said wheel axle.

13. The wheel system, as recited in claim 4, wherein said reinforcing panel has a predetermined width for spacedly mounting on said respective outer side of said traveling body, so as to further substantially increase a wheel length between said two wheels.

14. The wheel system, as recited in claim 6, wherein said reinforcing panel has a predetermined width for spacedly mounting on said respective outer side of said traveling body, so as to further substantially increase a wheel length between said two wheels.

15. The wheel system, as recited in claim 7, wherein said reinforcing panel has a predetermined width for spacedly mounting on said respective outer side of said traveling body, so as to further substantially increase a wheel length between said two wheels.

16. The wheel system, as recited in claim 9, wherein said reinforcing panel has a predetermined width for spacedly mounting on said respective outer side of said traveling body, so as to further substantially increase a wheel length between said two wheels.

17. The wheel system, as recited in claim 6, wherein said reinforcing panel is embodied to comprises three pieces perpendicularly with each other for fittedly mounting on a corner portion of said outer side of said traveling body.

18. The wheel system, as recited in claim 9, wherein said reinforcing panel is embodied to comprises three pieces perpendicularly with each other for fittedly mounting on a corner portion of said outer side of said traveling body.

19. The wheel system, as recited in claim 14, wherein said reinforcing panel is embodied to comprises three pieces perpendicularly with each other for fittedly mounting on a corner portion of said outer side of said traveling body.

20. The wheel system, as recited in claim 16, wherein said reinforcing panel is embodied to comprises three pieces perpendicularly with each other for fittedly mounting on a corner portion of said outer side of said traveling body.
